(19) United States
(12) Patent Application Publication
(10) Pub. No.: US 2008/0174525 A1
(43) Pub. Date: Jul. 24, 2008

(54) Plasma display device and voltage generator thereof

(76) Inventors: Kazuhiro Ito, Suwon-si (KR); Yoo-Jin Song, Suwon-si (KR); Sun-Kuk Kim, Suwon-si (KR)

Correspondence Address: ROBERT E. BUSHNELL, 1522 K STREET NW, SUITE 300, WASHINGTON, DC, 20005-1202, US

(21) Appl. No.: 11/987,022

(22) Filed: Nov. 26, 2007

(30) Foreign Application Priority Data
Jan. 19, 2007 (KR) 10-2007-0006212

(51) Int. Cl. G09G 3/28

(52) U.S. Cl. 345/63

(57) ABSTRACT

In plasma display device, a transistor includes a source terminal connected to a power supply that sequentially applies voltage pulses having a scan voltage to a plurality of scan electrode in a address period, and a drain terminal connected to a plurality of scan electrodes. A first resistor is connected between the source and the gate terminals of the transistor, and a second resistor is connected between the drain and the gate terminals of the transistor. A Zener diode is connected to the first resistor between the source and the gate terminals of the transistor. Therefore, a voltage finally applied to the plurality of scan electrodes can be generated using the same power supply that supplies the scan voltage in the falling period of the reset period.

### CLAIM OF PRIORITY

This application makes reference to, incorporates the same herein, and claims all benefits accruing under 35 U.S.C. §119 from an application for PLASMA DISPLAY DEVICE AND VOLTAGE GENERATOR THEREOF earlier filed in the Korean Intellectual Property Office on the 19 of Jan. 2007 and there duly assigned Serial No. 10-2007-0006212.

### BACKGROUND OF THE INVENTION

1. Field of the Invention

The present invention relates to a plasma display device, and a voltage generator thereof.

2. Description of the Related Art

A plasma display device is a flat panel display for displaying texts and images using plasma formed by gas discharge. A display panel of a plasma display device includes several hundred thousands to several millions of discharge cells disposed in a matrix formation depending on the size thereof. Hereinafter, a cell refers to a discharge cell.

In general, such a plasma display device is driven by dividing a frame into a plurality of subfields each having a grayscale weight value. The luminance of a cell is decided by the sum of weight values of subfields emitting light in a corresponding cell among the plurality of sub fields.

Each subfield includes a reset period, an address period, and a sustain period. The reset period is a period for initializing a wall charge state of a cell, and the address period is a period for selecting a light emitting cell and a non light emitting cell among discharge cells. The sustain period is a period for displaying an image by sustain-discharging the cell, which was set as a light emitting cell during the address period, for a period corresponding to the weight of corresponding subfields.

In general, the voltage of a scan electrode gradually increases to voltage Vset and gradually decreases to voltage Vnf in the reset period to initialize the state of discharge cell. In the address period, a scan pulse having a scan voltage VscL and an address pulse having voltage Va are applied to a scan electrode and an address electrode of turn-on discharge cells, respectively. Generally, voltage VscL is set to have a level identical to voltage Vnf. As described above, a proper address discharge is not induced if voltage Vnf and voltage VscL are identical, thereby low discharge is induced. If the voltage level of the address voltage increases to prevent the low discharge from being induced, address discharge is induced, thereby generating misfiring.

The above information disclosed in this Background section is only for enhancement of understanding of the background of the invention and therefore it may contain information that does not form the prior art that is already known in this country to a person of ordinary skill in the art.

### SUMMARY OF THE INVENTION

It is one aspect of the present invention to provide a plasma display device preventing a low discharge. It is another aspect of the present invention to provide a voltage generator for reducing the number of power supplies in a plasma display device.

An exemplary embodiment of the present invention provides a plasma display device including a plurality of electrodes, a power supply, a first switch, a first resistor, a second resistor, and a first diode. The power supply sequentially supplies a scan voltage to the plurality of electrodes in an address period. The first switch includes a first terminal connected to the plurality of electrodes and a second terminal connected the power supply. The first terminal of the first switch generates a first voltage. The first resistor is connected between a control terminal of the first switch and the plurality of electrodes. The second resistor is connected between the control terminal of the first switch and the power supply. The first diode is connected to the second resistor in parallel between the control terminal of the first switch and the power supply.

Magnitude of the first voltage is smaller than magnitude of the scan voltage. The first voltage may be applied to the plurality of the electrodes at a finishing point of a reset period.

The plasma display device may further include a second switch electrically connected between the second terminal of the first switch and the power supply, and the second switch may function as a ramp switch, and gradually decrease a voltage of the electrode to a first voltage in a reset period by repeatedly turning on and off the second switch, where magnitude of the first voltage is smaller than magnitude of the scan voltage.

The plasma display device may further include a third switch connected between the plurality of electrode and the power supply, and applying the scan voltage to the scan electrode when the third switch is turned on.

One of the first resistor and the second resistor may be a variable resistor, or resistor that has resistance varying according to temperature. The first switch may be a bipolar transistor.

Another embodiment of the present invention provides a voltage generator connected to each of a plasma display panel and a power supply supplying a first voltage. The voltage generator generates a second voltage, whose magnitude is smaller than magnitude of the first voltage. The voltage generator includes a switch, at least one first resistor, a second resistor, and a zener diode.

A first terminal of the switch is connected to the power supply. The first resistor is connected between the first terminal and a control terminal of the switch. The second resistor is connected between the control terminal and a second terminal of the switch. The zener diode is connected to the first resistor in parallel between the first terminal and the control terminal of the switch. Herein, a second voltage is generated at the second terminal of the transistor.

One of the first resistor and the second resistor may be a variable resistor.

The first voltage and the second voltage may be voltage used for driving the plasma display device having a plurality of electrodes. The first voltage may be a scan voltage sequentially applied to the plurality of electrodes in an address period, and the second voltage may be voltage of the plurality of electrodes at a finishing point of a reset period.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram illustrating a plasma display device according to an exemplary embodiment of the present invention;

FIG. 2 is a diagram illustrating a driving waveform of a plasma display device according to an exemplary embodiment of the present invention;

FIG. 3 is diagram illustrating a scan electrode driver constructed as an exemplary embodiment of the present invention;

FIG. 4 is a diagram illustrating a ΔV voltage generator constructed as a first exemplary embodiment of the present invention;

FIGS. 5A, 5B, and 5C are diagrams illustrating variable resistors replaced with resistors shown in FIG. 4;

FIG. 6 is a diagram illustrating a ΔV voltage generator constructed as a second exemplary embodiment of the present invention;

FIG. 7 is a diagram illustrating a ΔV voltage generator constructed as a third exemplary embodiment of the present invention; and

FIG. 8 is a diagram illustrating a ΔV voltage generator constructed as a fourth exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, and like reference numerals designate like elements throughout the specification.

When a first part is referred to as being “connected” to a second part, it could mean that the first part is directly connected to the second part, or it could also mean that the first part and the second part are “electrically connected” having a third element in-between throughout the specification. Furthermore, when a part is referred to as “including” a constituent element, it does not mean that the part excludes other constituent elements, but it means that the part can further include other constituent elements, unless otherwise specified.

Throughout the specification, a wall charge denotes a charge formed and accumulated on a wall of a discharge cell, for example, a dielectric layer, to be closely to each electrode. Although the wall charge does not contact to the electrode, the wall charge will be described as being “formed” or “accumulated” on the electrode, hereinafter. The wall voltage denotes potential difference formed on the wall of the discharge cell.

Throughout the specification, sustaining a voltage means includes voltage change in an allowable designing range and voltage change caused by a parasitic component which is ignored by in a view of designing of a person of an ordinary skill in the art, although the potential difference between two specific point changes with time. Since a threshold voltage of semiconductor device such as a transistor, a diode, and etc, is very low comparing to the discharge voltage, the threshold voltage is considered about 0V.

Hereinafter, a plasma display device, a driving method thereof, and a voltage generator thereof according to an exemplary embodiment of the present invention will be described with reference to accompanying drawings.

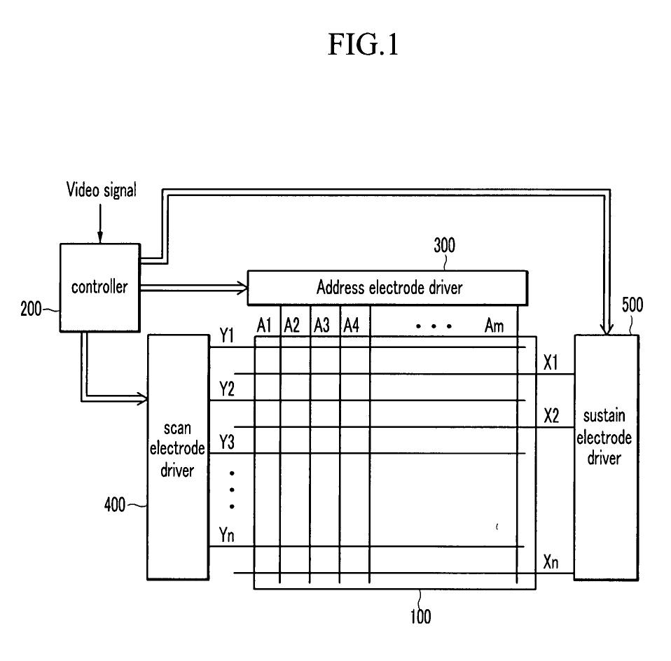

FIG. 1 is a schematic diagram illustrating a plasma display device according to an exemplary embodiment of the present invention. As shown in FIG. 1, the plasma display device of the present embodiment includes plasma display panel (PDP) 100, controller 200, address electrode driver 300, scan electrode driver 400, and sustain electrode driver 500.

Plasma display panel (PDP) 100 includes a plurality of address electrodes A1 to Am extending in a column direction, and a plurality of sustain electrodes X1 to Xn and a plurality of scan electrodes Y1 to Yn, both of which are extending in a row direction. Each of the sustain electrodes X1 to Xn are formed to be corresponding to each of the scan electrodes Y1 to Yn, and generally have one end commonly connected to each other. Plasma display panel (PDP) 100 includes a substrate (not shown) having sustain and scan electrodes X1 to Xn and Y1 to Yn, and a substrate (not shown) having address electrodes A1 to Am. Two substrates face each other, and the scan electrode Y1 to Yn and the sustain electrode X1 and Xn orthogonally cross the address electrodes A1 to Am. Discharge spaces are formed at intersections of the address electrodes and the sustain and scan electrodes. Herein, a discharge cell is formed by a discharge space formed at the crossing of the address electrodes A1 and Am, and the sustain and scan electrodes X1 to Xn and X1 to Yn. The structure of plasma display panel (PDP) 100 described above is only an example. Plasma display panels having other structures, to which following driving waveforms can be applied, can be applied to the present invention.

Controller 200 receives a video signal from an external device or circuit, and outputs an address electrode driving control signal, a sustain electrode driving control signal, and a scan electrode driving control signal. Controller 200 drives one frame by dividing it into a plurality of subfields. Each of the subfields includes a reset period, an address period, and a sustain period, if it is expressed in operation variation.

Address driver 300 receives the address electrode driving control signal from controller 200, and applies a display data signal to each of the address electrode for selecting a target discharge cell. Sustain electrode driver 500 receives a sustain electrode driving control signal from controller 200, and applies the driving voltage to the sustain electrode. Scan electrode driver 400 receives a scan electrode driving control signal from controller 200, and applies a driving voltage to a scan electrode.

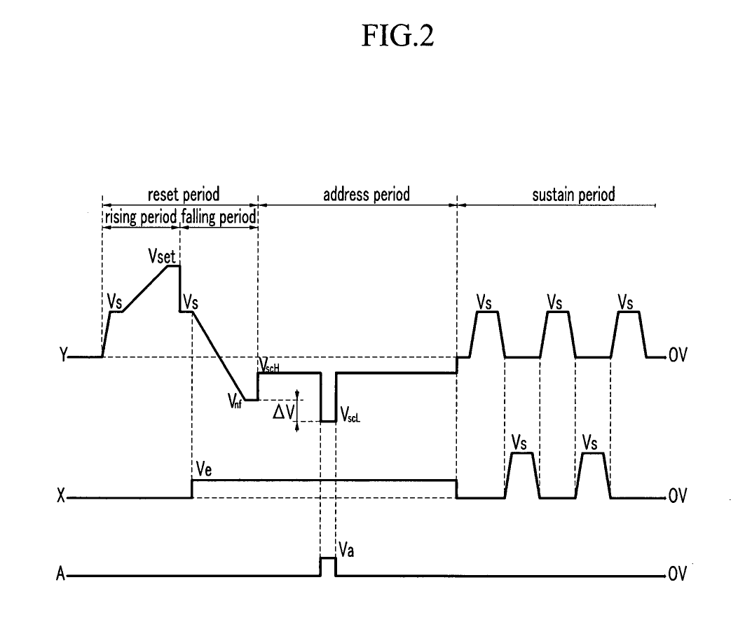

A driving waveform of a plasma display device according to an exemplary embodiment of the present invention will be described with reference to FIG. 2. FIG. 2 is a diagram illustrating a driving waveform of a plasma display device according to an exemplary embodiment of the present invention. For convenience, a driving waveform applied to one discharge cell formed of a scan electrode, a sustain electrode, and an address electrode will be described, hereinafter. An A electrode refers to the address electrode, an X electrode refers the sustain electrode, and a Y electrode refers the scan electrode.

As shown in FIG. 2, one subfield includes a reset period, an address period, and a sustain period, and the reset period includes a rising period and a falling period.

In the rising period of the reset period, the voltage of the Y electrode gradually increases from voltage Vs to voltage Vset while sustaining a reference voltage of the A electrode and the X electrode, for example, 0V in FIG. 2. In FIG. 2, the voltage of the Y electrode increases in a ramp pattern. While the voltage of the Y electrode increases, a weak discharge is induced between the Y electrode and the X electrode, and between the Y electrode and the A electrode, thereby forming a negative (−) wall charge at the Y electrode and forming a positive (+) wall charge at the X and A electrodes. When the voltage of electrode gradually changes as shown in FIG. 2, a weak discharge is induced at a discharge cell, and a wall charge is formed to sustain the sum of the voltage applied from the outside and the wall voltage of the discharge cell at about a discharge firing voltage state. Such an operation was introduced by Weber in U.S. Pat. No. 5,745,086. Since all discharge cell must be initialized in the reset period, voltage Vset should be high enough to induce discharge at all conditions of discharge cells. Voltage Vs is identical to a general voltage applied to the Y electrode in the sustain period, and lower than a discharge firing voltage between the Y electrode and the X electrode.

In the falling period of the reset period, the voltage of Y electrode gradually decreases from voltage Vs to voltage Vnf while maintaining the reference voltage to the A electrode and voltage Ve to the X electrode. As a result, a weak discharge is induced between the Y and X electrodes and between the Y and A electrodes while the voltage of the Y electrode decreases, thereby removing the negative (−) wall charge formed at the Y electrode and the positive (+) wall charge formed at the X and A electrodes. Generally, voltage Vnf is set to have a similar magnitude with the discharge firing voltage between the Y and X electrodes. Then, the wall voltage between the Y electrode and the X electrode becomes about 0V, thereby preventing a discharge cell that does not induce an address discharge in the address period from inducing a misfiring in the sustain period, wherein the misfiring denotes misfiring between the Y electrode and the X electrode. Since the voltage of the A electrode is sustained as the reference voltage, the wall voltage between the Y and A electrodes is determined by the level of voltage Vnf.

Then, a scan pulse having a scan voltage VscL and an address pulse having voltage Va are applied to the Y electrode and the A electrode, respectively to select a turn-on discharge cell while sustaining voltage Ve at the X electrode in the address period. Voltage VscH is applied to the unselected Y electrode. The magnitude of voltage VscH is smaller than the magnitude of voltage VscL. A reference voltage is applied to an A electrode of a turn-off discharge cell. Then, an address discharge is induced at a discharge cell formed by the Y electrode receiving the scan voltage VscL and the A electrode receiving the voltage Va, thereby forming a positive (+) wall charge at the Y electrode and forming a negative (−) wall charge at the A and X electrodes. In order to perform such operations, scan electrode driver 400 selects the Y electrode receiving the scan pulse having the scan voltage VscL among the scan electrodes Y1 to Yn. For example, the scan electrode can be sequentially selected in an order of arranging them in a vertical direction in a single driving. Address driver 200 selects an address electrode to apply an address pulse having voltage Va among the address electrode A1 to Am passing the discharge cell formed by the corresponding Y electrode when one of the Y electrodes is selected.

In a result, an address pulse having voltage Va is applied to a discharge cell to be turned on among discharge cells in the first row at the same time that a scan pulse having voltage VscL is applied to a scan electrode of the first row, for example, Y1 of FIG. 1. Then, a discharge is induced between the Y electrode and the. A electrode receiving the voltage Va, thereby forming a positive (+) wall discharge at the Y electrode and a negative (−) wall discharge at the A and X electrodes. As a result, a wall voltage Vwxy is formed between the X and Y electrode so as the potential of Y electrode is higher than the potential of the X electrode. Then, an address pulse having voltage Va is applied to an A electrode located at a discharge cell to display among discharge cells in the second row while applying a scan pulse having voltage VscL at a Y electrode of the second row, for example, Y2 of FIG. 2. As described above, an address discharge is induced at the Y electrode of the second row and the A electrode receiving voltage Va, thereby forming a wall charge at a discharge cell. A wall charge is formed by applying an address pulse having voltage Va to an A electrode located at a discharge cell to be turned on while sequentially applying a scan pulse having voltage VscL to an Y electrode.

The magnitude of the scan voltage VscL is greater than magnitude of voltage Vnf, which is an final voltage applied to an Y electrode in an finishing point of the reset period, by as much as voltage difference of ΔV according to an exemplary embodiment of the present invention. Herein, the reason why an address discharge is induced at a discharge cell when voltage Va is applied and how a low discharge is prevented if the magnitude of the scan voltage VscL is higher than the magnitude of voltage Vnf will be described.

The sum of the wall voltage between the A and Y electrode and a voltage applied from the outside between the A and Y electrode is determined by a discharge firing voltage Vfay between the A and Y electrode, when voltage Vnf, which is a final voltage, is applied to an Y electrode in the reset period.

However, in the case of applying 0V to an A electrode and a scan voltage VscL to a Y electrode in the address period, a discharge can be induced because a voltage higher than the Vfay voltage is formed between the A and Y electrodes. But, the discharge is not induced because a delay time is longer than the widths of the scan pulse and the address pulse.

In the case of applying voltage Va to an A electrode and a scan voltage VscL to a Y electrode, a voltage higher than a Vfay voltage is formed between the A and Y electrodes. Therefore, the discharge delay time is shortened compared to the widths of the scan pulse and the address pulse, thereby forming the discharge. In general, a voltage higher than voltage Vfay is formed between A and Y electrodes when a scan voltage identical to the voltage Vnf is applied to a Y electrode, thereby forming a discharge. In the present embodiment, a voltage between A and Y electrodes further increases by applying voltage VscL, which has higher absolute level than voltage Vnf by as much as ΔV, to a Y electrode. As a result, a discharge delay time can be further reduced. And an address discharge is well induced thereby. Therefore, the address low discharge can be prevented.

In the sustain period, a sustain discharge pulse having a high level voltage Vs and a low level voltage such as 0V are applied to a Y electrode and an X electrode alternatively with opposite phases. Then, a sustain discharge is induced in a selected discharge cell in the address period. The number of sustain pulses is corresponding to a weight value of a subfield.

In general, in order to set different magnitude for voltage VscL, which is a scan voltage applied in the address period, and voltage Vnf, which is a final voltage of a reset period, as like the driving waveform according to the present embodiment, an additional power supply is required to supply power for generating the voltage Vnf that is different from another power for generating the voltage VscL. Hereinafter, scan electrode driver 400 that generates two voltage using one power supply without requiring additional power supply will be described.

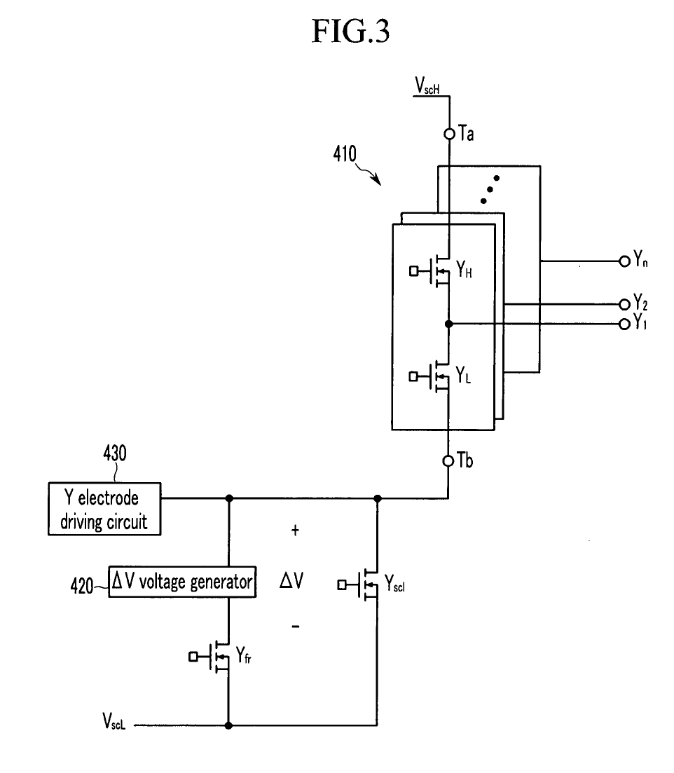

FIG. 3 is a circuit diagram illustrating a scan electrode driver constructed as an exemplary embodiment of the present invention. As shown in FIG. 3, the scan electrode driver includes a plurality of scan ICs 410, ΔV voltage generator 420, transistors Yfr and Yscl, and Y electrode driving circuit 430. In FIG. 3, each transistor is shown as an n-channel field effect transistor, particularly, an NMOS (n-channel metal oxide semiconductor) transistor. The transistors include a body diode formed from a source and a drain. Instead of using the NMOS transistor, other transistor having similar function can be used. In FIG. 3, the transistors are shown as individually formed transistor. However, the transistors can be formed as a plurality of transistor coupled in parallel.

Each of the plurality of scan ICs 410 include transistors Y_{H} and Y_{L}, and the plurality of scan ICs 410 commonly include terminal Ta and terminal Tb. The transistor Y_{H} includes a drain connected to the terminal Ta, and the transistor Y_{L} includes a source connected to the terminal Tb. The transistor Y_{H} includes a source connected to the drain of the transistor Y_{L}, and the junction thereof is connected to the scan electrodes Y1 to Yn. A power supply VscH supplies pulses having voltage VscH to the terminal Ta.

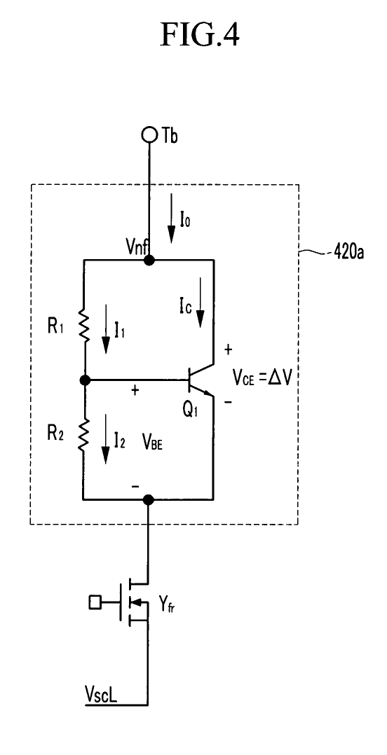

The transistor Yscl includes a drain connected to the terminal Tb of a plurality of scan ICs 410, and a source connected to a power supply VscL that supplies voltage VscL. ΔV voltage generator 420 is connected between the terminal Tb and the drain of transistor Yfr, and the source of transistor Yfr is connected to the power supply VscL that supplies pulses having voltage VscL. The transistor Yfr is a ramp switch that supplies a stable and constant current to an Y electrode when it is turned on, thereby gradually decreasing the voltage of the Y electrode. A method for gradually decreasing the voltage of the Y electrode by supplying a constant current to the Y electrode through the transistor Yfr is already known to a person of an ordinary skill in the art. Therefore, the detailed description there of will be omitted. ΔV voltage generator 420 generates ΔV (Vnf-VscL) voltage shown in FIG. 2 without requiring additional power supply. ΔV voltage generator 420 will be described in detail with reference to FIG. 4 to FIG. 7.

Meanwhile, Y electrode driving circuit 430 is connected to terminal Tb, thereby connected to the Y electrode, and generates various driving waveform such as a rising waveform of a reset period, and a sustain pulse, and etc, which are applied to the Y electrode. Since the structure of the Y electrode driving circuit 430 does not directly related to the present invention, the detailed description thereof will be omitted.

In the falling period of the reset period, the transistor Yfr and each transistor Y_{L} of a plurality of scan ICs 410 are turned on, and ΔV voltage generator 420 gradually decreases the voltage of the Y electrode to Vnf (VscL+ΔV). Although the voltage of Y electrode gradually decreases to the voltage VscL by turning on the transistor Yfr, the voltage of Y electrode decreases to Vnf (VscL+ΔV) because the ΔV, which is generated from ΔV voltage generator 420, is added thereto.

In the address period, the transistor Yscl is turned on, and the transistor Y_{L} of a scan IC corresponding to a scan electrode to be selected is turned on, thereby applying a scan voltage (VscL) to only the Y electrode. Herein, voltage VscH is applied to a scan IC corresponding to the unselected Y electrode because the transistor Y_{H} is turned on.

Hereinafter, ΔV voltage generator 420 that generates ΔV voltage will be described in detail with reference to FIG. 4 to FIG. 10.

FIG. 4 is a diagram illustrating ΔV voltage generator 420a constructed as the first exemplary embodiment of the present invention. ΔV voltage generator 420a includes transistor Q1, and resistors R1 and R2. Herein, the transistor Q1 is a bipolar transistor.

The transistor Q1 includes a collector connected to terminal Tb of a plurality of scan ICs 410, and an emitter connected to a drain of the transistor Yfr. The resistor R1 includes one end connected to the collector of the transistor Q1, for example, the terminal Tb, and the other end connected to the base of the transistor Q1. The resistor R2 includes one end connected to the base of the transistor Q1, and the other end connected to the emitter of the transistor Q1. The resistors R1 and R2 are connected to each other, and the junction thereof is connected to the base of the transistor Q1.

When a current Io is low, the transistor Q1 becomes off, thereby flowing the current Io only to the resistors R1 and R2. However, if the amount of the current Io increases enough to turn on the transistor Q1, the current Io flows to the transistor Q1 as well as to the resistors R1 and R2. The collector-emitter voltage V_{CE} of the transistor Q1 can be expressed as Equation 1.

V_{CE}=I1*R1+I2*R2 Equation 1

In Equation 1, if the base current of the transistor Q1 is ignored, I1=I2. The current I2 becomes I2=V_{BE}/R2. Therefore, the collector-emitter voltage V_{CE} of the transistor Q1 can be expressed as Equation 2.

V_{CE}=(1+R1/R2)*V_{BE} Equation 2

Herein, the collector-emitter voltage V_{CE} of the transistor Q1 is a ΔV voltage generated from ΔV voltage generator 420a. Referring to Equation 2, the collector-emitter voltage (V_{CE}=ΔV) of the transistor Q1 can be set to a desired value in proportion to the base-emitter voltage V_{BE} of the transistor Q1 if the ratio of sizes of the resistors R1 and R2 is adjusted.

That is, ΔV voltage generator 420a of the first exemplary embodiment of the present invention can generate ΔV value as shown in Equation 2, and the ΔV value is determined by the resistances of the resistors R1 and R2, and the base-emitter voltage V_{BE} value of the transistor Q1. Even if the base-emitter voltage V_{BE} of the transistor Q1 is a value predetermined by the characteristic of the transistor Q1, the ΔV can be set by changing the value of resistors R1 and R2. Particularly, the ΔV value shown in FIG. 2 is required to be set to various values in order to improve the low discharge. The ΔV value can be set to various values by changing the resistances of the resistors R1 and R2 through the ΔV voltage generator according to the first embodiment of the present invention.

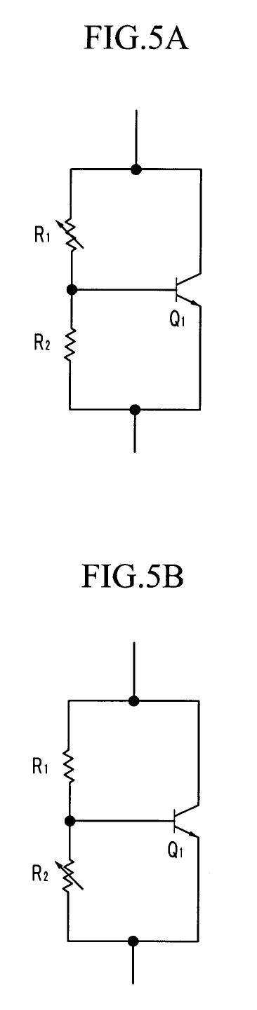

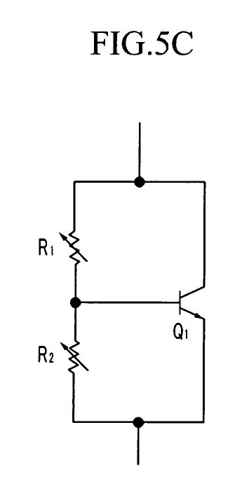

As shown in FIG. 5, resistors R1 and R2 can be replaced with variable resistors. As shown in FIGS. 5A, 5B, and 5C, it is possible to replace only one of the resistors R1 and R2 with a variable resistor. In the case of replacing the resistors R1 and R2 with a variable resistor, it is possible to control the ΔV value to a desired value by controlling the variable resistors R1 and R2 after designing. Therefore, the low discharge can be further improved.

The resistors R1 and R2 can be replaced with resistors that have varying resistance depending on temperature. That is, resistors R1 and R2 can be set to have a positive temperature coefficient (PCT) characteristic that increases resistance according to the increment of temperature, or can be set to have a negative temperature coefficient (NTC) characteristic that decreases resistance according to the decrement of temperature. When the temperature decreases, the issue of an address low discharge becomes more serious because the motion of a wall charge in a discharge cell is slow. In this case, the resistor R1 is set to have the NTC characteristic, and the resistor R2 is set to have the PTC characteristic. Then, the ΔV value become greater according to the Equation 2 when the temperature becomes decreased. Therefore, it can overcome the problem of the address low discharge becoming more serious when the temperature decreases.

The problems caused by the temperature characteristics can be solved by adaptively setting the resistors R1 and R2 with resistors that have resistance varying depending on temperature.

In the first exemplary embodiment of the present invention, the transistor Q1 is a bipolar transistor. However, it can be replaced with a MOSFET (Metal-Oxide Semiconductor Field Effect Transistor) or an IGBT (insulated Gate Bipolar Transistor). Hereinafter, it will be described in detail.

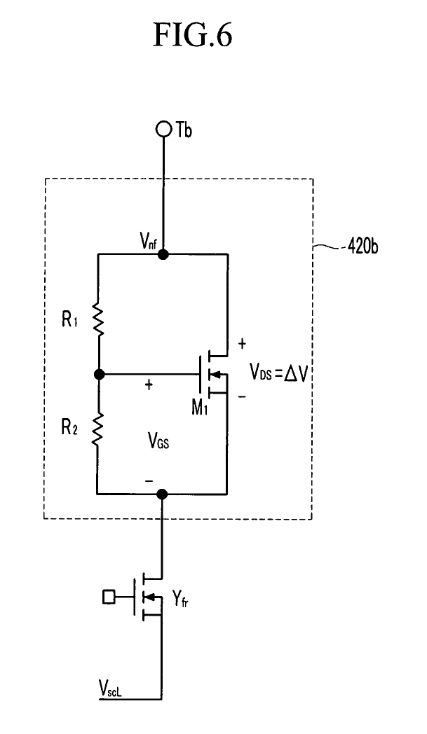

FIG. 6 is a diagram illustrating ΔV voltage generator 420b constructed as a second exemplary embodiment of the present invention. As shown in FIG. 6, ΔV voltage generator 420b according to the second exemplary embodiment of the present invention is identical to that according to the first embodiment except that a transistor M1 is a MOSFET (Metal-Oxide Semiconductor Field Effect Transistor). Therefore, overlapped description will be omitted.

Since the transistor Q1 of the ΔV voltage generator in the first exemplary embodiment is replaced with the MOSFET M1 in the ΔV voltage generator of the second exemplary embodiment, the ΔV voltage, which is a drain-source voltage V_{DS} of the transistor M1, can be expressed as following Equation 3.

V_{DS}=(1+R1/R2)*V_{GS} Equation 3

In Equation 3, V_{GS} is a gate-source voltage of the transistor M1. As shown in Equation 3, the base-emitter voltage V_{BE} of the transistor Q1 is replaced with the gate-source voltage V_{GS} in Equation 3 if the transistor M1 is MOSFET.

As described above, the ΔV value is controlled by the gate-source voltage V_{GS} of transistor M1 and the resistors R1 and R2 in ΔV voltage generator 420b according to the second exemplary embodiment of the present invention as shown in Equation 3.

In ΔV voltage generator 420b of the second exemplary embodiment of the present invention, it is possible to replace the resistors R1 and R2 with variable resistors as like the ΔV voltage generator of the first exemplary embodiment.

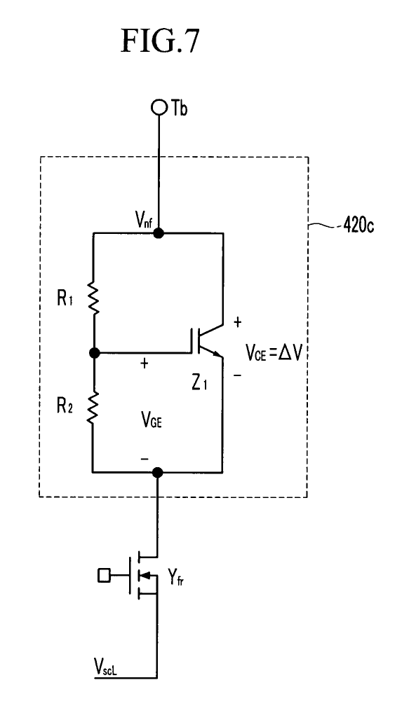

FIG. 7 is a diagram illustrating ΔV voltage generator 420c constructed as a third exemplary embodiment of the present invention. As shown in FIG. 7, ΔV voltage generator 420c according to the third exemplary embodiment of the present invention is identical to that according to the first embodiment except that a transistor Z1 is an IGBT (insulated Gate Bipolar Transistor). Therefore, overlapped description will be omitted.

Since the transistor Z1 is replaced with the IGBT in ΔV voltage generator 420c of the third exemplary embodiment of the present invention, the ΔV voltage, which is the collector-emitter V_{CE} of the transistor Z1 can be expressed as Equation 4.

V_{CE}=(1+R1/R2)*V_{GE} Equation 4

In Equation 4, V_{GE} denotes a gate-emitter voltage of the transistor Z1. As shown in Equation 4, the base-emitter voltage V_{BE} of the transistor Q1 in Equation 2 is replaced with the gate-emitter voltage V_{GE} of the transistor Z1 when the transistor Z1 is the IGBT.

The ΔV value can be controlling by the gate-emitter voltage V_{GE} of the transistor Z1 and the values of the resistors R1 and R2 in the ΔV voltage generator 420c according to the third exemplary embodiment of the present invention as shown in Equation 4.

It is also possible to replace the resistors R1 and R2 with variable resistors, and a resistor having resistance varying according to temperature in ΔV voltage generator 420c of the third exemplary embodiment of the present invention as like that of the first exemplary embodiment of the present invention.

As like the first exemplary embodiment, if a bipolar transistor is used as a switch used in the ΔV voltage generator, the bipolar transistor is not adequate for applying high voltage between the collector and the emitter. Therefore, it can be damaged if higher than 30V is applied between the base and the emitter. Hereinafter, a ΔV voltage generator than can prevent a bipolar transistor from being damaged will be described.

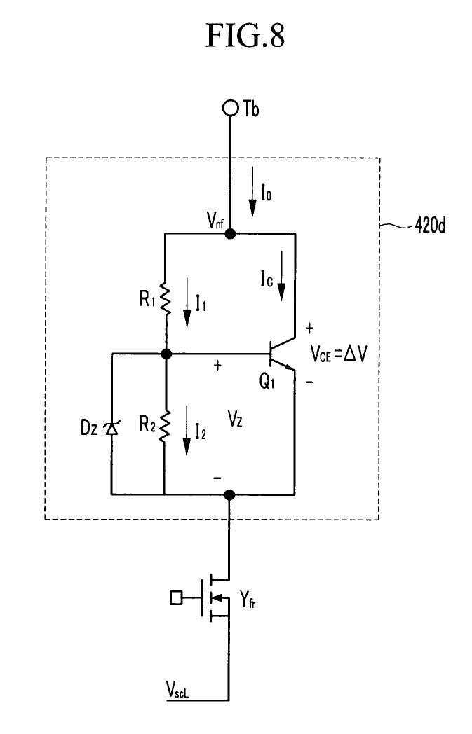

FIG. 8 is a diagram illustrating ΔV voltage generator 420d constructed as a fourth exemplary embodiment of the present invention. As shown in FIG. 8, ΔV voltage generator 420d according to the fourth exemplary embodiment of the present invention is identical to that according to the first embodiment except that a Zener diode Dz is added. Therefore, overlapped description will be omitted. The Zener diode Dz includes a cathode connected to a base of a transistor Q1, and an anode connected to an emitter of the transistor Q1. In FIG. 8, Vz denotes a breakdown voltage of the Zener diode Dz. The Zener diode Dz is designed as an element having a breakdown location within an inner pressure of the transistor Q1.

A ΔV voltage generated from ΔV voltage generator 420d according to the fourth exemplary embodiment can be calculated by a method identical to Equation 2 by replacing V_{BE} with Vz. If the base current of the transistor Q1 is ignored, current I1 and current I2 are the same, i.e. I1≈I2, and I2=(V_{BE}+Vz)/R2. Therefore, if it is applied to Equation 1, the ΔV voltage generated from ΔV voltage generator 420d of the fourth exemplary embodiment can be expressed as Equation 5.

ΔV=(1+R1/R2)*(Vz) Equation 5

According to the fourth exemplary embodiment of the present invention, it can prevent the transistor Q1 from being damaged, because it prevents voltage exceeding the inner pressure of the transistor Q1 from being applied to between the base and emitter of the transistor Q1.

As described above, as like the first exemplary embodiment, it is possible to replace the resistors R1 or the resistor R2 with variable resistors or with resistors having resistance varying according to temperature in the fourth exemplary embodiment of the present invention.

The transistor included in the ΔV voltage generator as shown in FIGS. 4, 6, 7, and 8 can be referred to as a first switch. Emitter or source of the transistor can be referred to as a first terminal, and collector or drain of the transistor can be referred to as a second terminal. The term of the first terminal and the second terminal can be interchangeably used. For example, an emitter can be referred to as a second terminal, then a collector can be referred to as a first terminal. Base or gate of the transistor can be referred to as a control terminal. Transistors Yfr and Yscl can be referred to as a second switch and a third switch, respectively.

According to an exemplary embodiment of the present invention, the final voltage and a scan voltage in the reset period can be generated using one power supply. Also, various ΔV voltage can be generated by simply changing the resistors R1 and R2. Furthermore, the reliability of the circuit can be improved by adding a Zener diode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plurality of electrodes;
a power supply adapted to sequentially supply a scan voltage to the plurality of electrodes in an address period;
a first switch having a first terminal, a second terminal, and a control terminal, the first terminal coupled to the plurality of electrodes and a second terminal coupled to the power supply, the first terminal generating a first voltage;
a first resistor connected between the control terminal of the first switch and the plurality of electrodes;
a second resistor connected between the control terminal of the first switch and the power supply; and
a diode connected to the second resistor in parallel between the control terminal of the first switch and the power supply.

2. The plasma display device of claim 1, wherein magnitude of the first voltage is smaller than magnitude of the scan voltage.

3. The plasma display device of claim 2, wherein the first voltage is applied to the plurality of the electrodes at a finishing point of a reset period.

4. The plasma display device of claim 1, further comprising a second switch connected between the second terminal of the first switch and the power supply.

5. The plasma display device of claim 4, wherein the second switch includes a ramp switch, the second switch gradually decreasing voltage being applied to the electrodes in a reset period to the first voltage at a finishing point of the reset period by repeatedly being turned on and off, where magnitude of the first voltage is smaller than magnitude of the scan voltage.

6. The plasma display device of claim 5, further comprising a third switch connected between the plurality of electrodes and the power supply, the third switch supplying the scan voltage to the electrodes when the third switch is turned on.

7. The plasma display device of claim 1, wherein the first resistor or the second resistor includes a variable resistor.

8. The plasma display device of claim 1, wherein the first resistor or the second resistor includes a variable resistor having resistance varying according to temperature.

9. The plasma display device of claim 1, wherein the first switch includes a bipolar transistor.

10. The plasma display device of claim 1, wherein the diode includes a Zener diode.

11. A voltage generator coupled to each of a plasma display panel and a power supply supplying a first voltage, the voltage generator comprising:
a switch having a first terminal, a second terminal, and a control terminal, the first terminal coupled to the power supply, a second voltage being generated at the second terminal, magnitude of the first voltage being greater than magnitude of the second voltage;
a first resistor connected between the first terminal and the control terminal of the switch;
a second resistor connected between the control terminal and the second terminal of the switch; and
a Zener diode connected to the first resistor in parallel between the first terminal and the control terminal of the switch.

12. The voltage generator of claim 11, wherein one of the first resistor and the second resistor is a variable resistor.

13. The voltage generator of claim 11, wherein the first voltage and the second voltage are supplied to a plurality of electrodes of the plasma display panel.

14. The voltage generator of claim 13, wherein:
the first voltage includes a scan voltage sequentially applied to the plurality of electrodes in an address period; and
the second voltage is applied to the plurality of the electrodes at a finishing point of a reset period.

15. The voltage generator of claim 11, wherein the first resistor or the second resistor includes a variable resistor having resistance varying according to temperature.

16. The voltage generator of claim 11, wherein the switch includes a bipolar transistor.
